(19) United States
(12) Patent Application Publication
(10) Pub. No.: US 2009/0283014 A1
(43) Pub. Date: Nov. 19, 2009

(54) Coating System

(76) Inventors: Martin Schichtel, Saarbrucken (DE); Jörg Jodlauk, Sulzbach (DE)

Correspondence Address: Frost Brown Todd, 2200 PNC Center, 201 East Fifth Street, Cincinnati, OH, 45202, US

(21) Appl. No.: 11/794,517

(22) PCT Filed: Jan. 2, 2006
(86) PCT No.: PCT/EP06/00006

§ 371 Date: Jun. 28, 2007

(30) Foreign Application Priority Data
Dec. 31, 2004 (DE) 10-2004-063-820.3

(51) Int. Cl. C09D 1/00; C07F 7/02

(52) U.S. Cl. 106/287.13; 106/287.17; 977/773

(57) ABSTRACT

The invention provides a coating system, particularly for coating concrete, concrete-like, mineral and/or ceramic substrates. The coating system comprises a binder consisting at least in part of an inorganic phosphatic binder, and fillers. The fillers include nano-scale particles having an average particle diameter d50 of less than 300 nm.

The invention relates to a coating system, and particularly to the coating of bricks and facades, comprising a binder system on the basis of an inorganic phosphatic binder, and fillers.

Such coating systems are known from the prior art. WO 01/87798 A2, for example, describes a wear-resistant composite protective layer which is produced via chemical bonding using mono-aluminum phosphate (Al(H₃PO₄)₃). This process comprises the preparation of hydroxide ceramics which subsequently to phosphatizing is hardened and sintered, respectively, by a heat treatment between 200 and 1200° C.

WO 85/05352 describes an example of a contact layer between ceramic and metallic materials, which is reinforced by a mono-aluminum phosphate agent. Hardening is performed in the course of the sintering process between 1000 and 1250° C.

DE 600 02 364 T2 describes an aluminum-wettable protective layer for carbon components which are to be protected by a substrate against corrosive attack. In this case, the layer contains particles of metal oxides or partly oxidized metals in a dried colloidal carrier which, among others, may contain mono-aluminum phosphate. The ceramic layer is hardened by a contact with molten aluminum.

U.S. Pat. No. 3,775,318 describes mixtures of earth alkali fluorides which are bound to a protective layer by means of an aluminum phosphate binder which is present in an inorganic solvent. After the corresponding protective layer has been applied, hardening is performed in a temperature range above 100° C. for several hours at environmental atmosphere.

The inorganic phosphates used as the binder phase in the described prior art are cross-linked via thermally activated reactions. This requires a temperature treatment which often takes several hours to dimensionally stably through-harden the protective layer.

It is the object of the invention to provide a coating system on the basis of an inorganic phosphatic binder as the binder phase which can be hardened at lower temperatures and/or within lesser time.

It is a further object of the invention to provide a coating system on the basis of an inorganic phosphatic binder as the binder phase which provides for the manufacture of protective layers having improved characteristics as compared to the prior art, e.g. improved adhesive strength, increased corrosion resistance or improved weathering resistance.

This object is attained by a coating system having the features of claim 1. Preferred embodiments and further developments of the invention are stated in the subclaims.

The invention provides a coating system comprising a binder which ate least in part consists of a phosphatic binder, and fillers. In this case a binder in the sense of the present invention is the non-volatile proportion of a coating material without pigment or filler but including any existing softening agents, desiccants and other non-volatile auxiliary agents. The binder binds fillers and pigment particles, respectively, with each other and with the foundation (substrate).

In the sense of the present invention the term “coating system” is to comprise both the starting material for manufacturing a coating (formulation as to the application) and the hardened layer. In other words, the coating system of the present invention comprises an aqueous or powdery material suitable for manufacturing the corresponding layer, and the corresponding layer after the material has been applied and hardened.

A filler in the sense of the present invention is a (mostly powdery) substance which is practically insoluble in the application medium, which may be used, e.g., to increase the volume (price reduction), to obtain or enhance technical effects and characteristics of the protective layer and/or to influence the processing properties. According to the invention at least part of the fillers consists of nano-scale particles having an average particle diameter d50 smaller than or equal to 300 nm.

The inventors of the present invention have found that by adding nano-scale particles the hardening of the phosphatic binder phases may be substantially accelerated. In this manner coating systems can be provided which may be hardened even at room temperature.

Preferably, the average particle diameter d50 of the nano-scale particles is 250 nm or less. Nano particles in a dimensional range of a d50 value of less than 200 nm are particularly preferred. Results which are especially favorable can be obtained with nano particles in a dimensional range of a d50 value of less than 100 nm. Very good results can be obtained by using nano particles in a dimensional range of a d50 value of less than 60 nm and the results will be optimal if nano particles in a dimensional range of less than 20 nm are used.

The d50 characteristic value normally used to characterize the particle size in the relevant art is defined via the probability theory and says that 50% of the measured particles are smaller than the corresponding measured value. It is based on a common statistical description of the size distribution of the particles in a disperse system of various particle sizes; cf. “Practice Guide Particle Size Characterization”, A. Jillavenkatesa, S. J. Dapkunas, Lin-Sein H. Lum, National Institute of Standards and Technology, Special Publication 960-1, January 2001, pp. 129-133.

In practice it is possible to measure the d50 value using various methods, among others, laser diffraction based on ISO 13320-1, edition 1999-11; particle size analysis by photon correlation spectroscopy DIN ISO 13321, edition 2004-10; particle size analysis using a dispersion method for powder in liquids according to ISO 14887, edition 2000-09; or using particle size analysis dispersion methods for powder in liquids according to BS ISO 14887, edition 2001-03-15. The standardization of the corresponding methods ensures that the same measurement value is obtained using the different methods.

By addition the nano particles selected binder systems according to the invention on the basis of a phosphatic binder phase can be converted into the dust-dry state in drying times of 30 seconds to about 60 minutes and hardening-through can be realized in drying times of up to 8 hours at room temperature. In many cases the addition of nano particles renders unnecessary the thermal activation of the condensation processes. It is assumed without any confirmed knowledge that the high specific surface of the nano particles favors the condensation reaction of the phosphates and possibly even “catalyses” it.

In this context the inventors found that the minimum nano particle content presents no critical factor of the compositions and that the inventive effect can be obtained even in case of compositions with low nano particle contents of 0.2 to 0.5 percent by weight, based on the solid phase.

Apart from accelerated hardening additional advantages result from the inventive compositions adapted according to the application case with respect to freeze-thaw cycle stability, chemical stability, adhesive strength and weathering stability in general.

Moreover, the coating system according to the invention enables the manufacture of protective layers which provide clearly enhanced results as a diffusions barrier against, e.g., moisture or aggressive compounds (corrosion protection) as compared to conventional compositions. Because of this the conclusion can be drawn that not only the reaction kinetics of the hardening mechanism but also the microstructure of the resulting layer on the basis of phosphatic binder phases can be substantially improved by the inventive addition of nano particles.

The inventive coating system provides further advantages with respect to concrete and a mineral foundation, respectively due to considerably promoted adhesion. Depending on the application case, this can be attributed to an interaction of the nano particles and the phosphatic binder in combination with substrate components such as CSH (calcium silicate hydrate). The results are protective layers having a considerably improved adhesive strength and considerably increased weathering resistance as compared to known systems.

Principally, the inventive coating system is suited for coating any foundations (substrates), particularly, however, for concrete, concrete-like, mineral and ceramic foundations. Therefore, in practice it is predestined especially for roof tiles and facades.

According to the invention the phosphatic binder consist of at least one phosphate of the group consisting of alkali polyphosphates, polymer alkali phosphates, silicophosphates, mono-aluminum phosphate, boron phosphate, magnesium sodium phosphate, alkali silicophosphate, phosphate glass, zinc phosphates, magnesium phosphates, calcium phosphates, titanium phosphates, chromium phosphates, iron phosphates and manganese phosphates.

It is preferred to use mono-aluminum phosphate, a content of 90% with reference to the binder providing particularly good results. It is advantageous to use the mono-aluminum phosphate (MAP) as a 50 to 60% aqueous solution.

As nano-scale particles it is preferred to use compounds of an oxide and/or hydroxide of the group consisting of aluminum, titanium, zinc, tin, zirconium, silicon, cerium and magnesium or mixtures of these compounds.

Moreover, the nano-scale particles may also comprise one or more compounds of the group consisting of silicon carbide, titanium carbide and tungsten carbide and/or the corresponding nitrides.

For optimization the binder system may be present as an aqueous solution to which a sol of the group consisting of acid stabilized silica sol, aluminum sol, zirconium sol, titanium dioxide sol, bismuth sol and tin oxide sol has been supplementarily added.

However, the type and combination of the used nano particles is not limited to these compounds and other nano particles known to the skilled person may be used which were manufactured using the usual procedural methods, such as sol-gel routes, etc.

The combination of the other used fillers primarily depends on the desired application and is established accordingly. As additional solid materials beside the nano particles the fillers may comprise, e.g., one or more oxides of the group consisting of quartz, cristobalitei, aluminum oxide, zirconium oxide and titanium dioxide. Good results can be obtained if the d50 value of these compounds is within the range of 500 μm to 500 μm, preferably in the range of 500 nm to 10 μm.

By adding suitable fillers, such as colorants, pigments, dusing phases etc. the inventive coating system may be functionalised within wide limits. As further examples for functional fillers (effective materials) fillers may be used which are photocatalytically active, have a hydrophobic and/or oleophobic effect and/or stop a microbial contamination of the surface by means of radiation. Furthermore, they may have a heat insulating and/or sound insulating effect.

Apart from that, non-oxidic compounds may also be used as fillers. As examples silicon carbide, aluminum nitride, boron carbide, boron nitride, titanium nitride, titanium carbide, tungsten carbide or mixed carbides therefrom are to be mentioned. Preferred d50 values of the non-oxidic compositions are in the range of between 700 nm and 60 μm. It is possible to obtain good results in particular, if a d50 value of the non-oxidic fillers in the range of 1 μm to 12 μm is used.

Besides, silicatic raw materials, for example of the group consisting of clay, kaolins and loams, preferably having a d50 value of <70 μm, can be used as fillers beside the nano particles. Improved results are obtained from the use of a d50 value of the silicatic raw materials in the range of between 4 μm and 45 μm. Other glasses or glass-like materials and/or metals may be used.

Principally, the nano-scale particles may be present in the binder matrix in a homogeneously distributed manner. Due to the costs involved it may make sense to distribute the nano-scale particles inhomogeneously in the binder matrix by increasing the concentration of the nano-scale particles in the surface area of the further fillers. This may be realised, for example, by a directed coating of the other fillers with the nano particles before the binder phase is added. In this course the nano-scale particles can attach to the surface of the other fillers by chemical and/or physical coupling. It is possible, for example, to obtain chemical coupling between the nano particles and the surfaces of the fillers by means of lactic acid.

Advantageously, the water content in aqueous compositions of the inventive coating system is in the range of between 15 and 35 percent by weight. A water content that is too high may shift the reaction balance in an unfavorable manner so that no reaction occurs. If the water content is too low the reaction may start too early which reduces pot time correspondingly.

Preferred embodiments and particular variations of the coating system according to the invention will be described below with reference to the FIGURE.

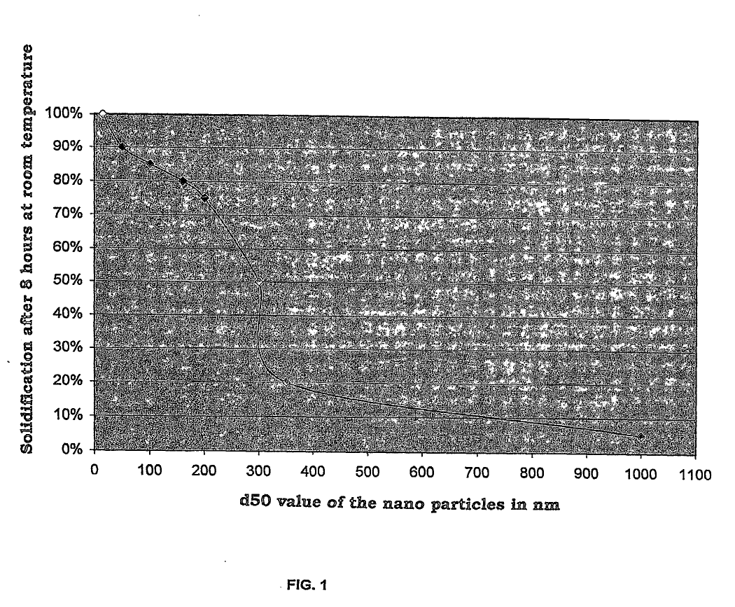

FIG. 1 shows the dependence of the solidification of the used particle sized for a composition of embodiment 1.

In all cases of the embodiments the coating system was applied to concrete. It was preferred to perform the application by spraying (0.8 mm nozzle, 1.8 bar pressure). The set dry layer thickness was in the range of between 40 μm-60 μm, however, it may moreover be varied in wide limits. Further application methods such as spreading, roll coating, spin-coating, flooding, dipping or bell-coating may be performed analogously.

A first embodiment has the following composition in percent by weight:

30.0% of mono-aluminum phosphate
1.6% of ammonium acetate
15.0% of silica sol 8-10 nm
3.4% of lithium acetate
15.0% of aluminum oxide 15 nm
20.0% of dolomite
10.0% of barium sulphate
5.0% of titanyl sulphate

Here a mixture of silica sol having a d50 value of 8-10 nm and aluminum oxide having a d50 value of 15 nm was used as nano particles.

This acidic composition enables excellent pot times (>6 months) in combination with a very good performance in the industrial field. The time to dust-dry after application is 10 to 60 seconds. After drying the resulting layer shows a high abrasion stability of PEI=4 according to DIN EN ISO 10545, part 7.

This embodiment provided more than 300 cycles of corrosion resistance according to ISO 16151.

FIG. 1 shows the solidification in percent wherein a solidification of 100% characterizes the complete transition of an applied paint or lacquer from the liquid to the solid state, cf. Lackformulierungen und Lackrezeptur, B. Müller, U. Poth, Vincentz-Verlag, 2003, p. 23. The illustration shows that in the case of particle sizes of the nano particles in the range of a d50 value larger than 350 to 1000 nm the solidification obtained with maximum values of 20% is very low.

If the particle size diameter decreases below 350 nm the degree of solidification strongly increases with the sinking particle size. At a particle size of 300 nm it already reaches a value of 50% and at 200 nm increases by a further 25% to 75%. The values of 80%, 85% and 90% are achieved at 160, 100 and 50 nm, respectively. A complete solidification of the coating of 100% can be obtained at a particle size of 15 nm. The solidification value shown in FIG. 1 was measured after a standing time of 8 hours.

As shown by this embodiment, especially the use of nano-scale aluminum oxide in combination with mono-aluminum phosphate as the binder phase is particularly advantageous because in the case of a given composition of the coating characteristic values of the material are obtained with could not be obtained in the same composition without nano-scale material.

A second embodiment of the present invention has the following combination in percent by weight:

25.0% of lithium water glass
10.0% of monoethanol amine
22.0% of basically stabilized MAP
10.0% of acetic acid
28.0% of n-SiO₂
5.0% of zinc phosphate

In this composition amorphous SiO₂ was used as nano-scale material, the d50 value of the material being 8 μm. This basic composition enables the forming of slightly porous layers (porosity about 6%) which allows gases and water vapour to penetrate due to a small pore diameter but bars liquids (water drops, for example).

Table 1 shows a third embodiment, wherein five different compositions were prepared which differed with respect to their contents of nano-scale material. More precisely, nano-scale aluminum oxide (d50 value of 12 nm) having contents between 0.5 and 15.02 percent by weight was used. The other fillers talcum, calcium bentonite, aluminum borate, Spinel black, SiC and mica were added as further fillers and were not present as nano-scale materials. The particle size for the fillers was 12 μm (d50) for talcum, 5 μm (d50) for calcium bentonite, 30 μm (d50) for aluminum borate, 4 to 10 μm (d50) for Spinel black, and 10 μm (d50) for SiC.

TABLE 1

| | Compo- | Compo- | Compo- | Compo- | Compo- |
|---|---|---|---|---|---|
| | sition | sition | sition | sition | sition |
| | 1 | 2 | 3 | 4 | 5 |
| MAP | 64.32 | 64.32 | 64.32 | 64.32 | 64.32 |
| N—Al₂O₃ | .50 | 1.25 | 4.02 | 10.02 | 15.02 |
| talcum | 2.25 | 1.26 | 1.26 | 1.26 | .76 |
| (layered | | | | | |
| silicate) | | | | | |
| calcium | 3.26 | 3.26 | 1.26 | 1.26 | .76 |
| bentonite | | | | | |
| aluminum | .5 | .5 | .5 | .5 | .5 |
| borate | | | | | |
| Spinel | 11.56 | 11.56 | 11.56 | 9.56 | 7.56 |
| black (Al—Mg | | | | | |
| mixed | | | | | |
| oxide) | | | | | |
| malonic | 1.01 | 1.01 | 1.01 | 1.01 | 1.00 |
| acid | | | | | |
| SiC | 14.07 | 14.07 | 14.07 | 10.07 | 9.07 |
| mica | 2.53 | 2.77 | 2.01 | 2.00 | 1.01 |
| (layered | | | | | |
| silicate) | | | | | |

For the inventive combinations 1 to 5 shown in Table 1 the GT/TT values depending on the nano particle content and the solidification depending on the nano particle content, respectively are stated in Tables 2 and 3. The comparative example denotes a corresponding composition without nano particles in which an aluminum oxide having a d50 value of 10 μm was used instead of N—Al₂O₃.

The cross-cut adhesion (GT characteristic value) is determined according to DIN 53151. GT=0 denotes a completely smooth cut edge with no section of the coating chipped off. GT=1 denotes a state in which small splinters of the coating are chipped off at the intersections of the grid lines, the chipped off surface corresponding to about 5% of the sections of the grid. GT=2 denotes a state in which the coating is chipped off in chunks along the cut edges and/or the intersections, corresponding to about 15% of the surface of the sections. GT=3 denotes a state in which the coating is chipped off along the cut edges and in the bordered surfaces, corresponding to about 33% of the surface.

In the so-called “tape test” a piece of adhesive tape is stuck over the cut grid and torn off with a yank. An assessment of TT=0 corresponds to no peeling of the coating. TT=1 denotes slight peeling along the cut edges and TT=9 denotes complete peeling even in the case that the sample has survived the GT test without any peeling.

The GT/TT values shown in Table 2 prove that the addition of 0.5% of nano particles can considerably improve the GT value from 4 to 1 as well as the TT value from 7 to 2. In both cases a clearly lower peeling tendency of the coating results. The characteristic values of GT=1 and TT=2 obtained in composition 1 are suited for a practical application of the corresponding layers.

TABLE 2
GT/TT Values Depending on the Nano Particle Content

| Composition | Nano Particles in w/w | GT | TT |
|---|---|---|---|
| Comparative Example | 0 | 4 | 7 |
| 1 | .5 | 1 | 2 |
| 2 | 1.25 | 0 | 1 |
| 3 | 4.02 | 0 | 0 |
| 4 | 10.02 | 0 | 0 |
| 5 | 15.02 | 0 | 0 |

The solidification values shown in Table 3 depending on the nano particle content also show that by adding 0.5 percent by weight of Al₂O₃ in the form of nano particles the standing time at room temperature required for solidification of 100% can be reduced by about 33% from >24 to 16. With an increasing content of nano-scale material the necessary solidification time further decreases. At a nano particle content of 15.02 percent by weight it is possible to obtain solidification already within 1 to 2 hours.

TABLE 3
Solidification Depending on the Nano Particle Content

| Composition | Nano Particles in w/w | Time [h] |
|---|---|---|
| Comparative Example | 0 | >24 |
| 1 | .5 | >16 |
| 2 | 1.25 | >12 |
| 3 | 4.02 | 8-8.5 |
| 4 | 10.02 | 5-6 |
| 5 | 15.02 | 1-2 |

It can be seen from the results of Tables 1 to 3 that small proportions of nano particles in the range of 0.5 percent by weight suffice to obtain the inventive effect which in the present embodiment 3 additionally lies in an improved adhesive strength of the protective layer.

Moreover, additional experiments have shown that in many application cases it is possible to obtain an increased adhesive strength already at contents of 0.1 to 0.2 percent by weight.

It follows from the results that not only the hardening can be substantially improved by adding the nano particles but moreover that the invention may provide coatings the adhesive strength of which is clearly enhanced.

The invention is not limited to the compositions shown above and principally comprises any form of application of phosphatic binder phases in combination with nano particles which means that in many cases it is no longer necessary to thermally activate the condensation of the phosphates and the cross-linking can be performed in much shorter time. Furthermore, the addition of nano particles changes the microstructure of the protective layer which may obtain a clear improvement with respect to adhesive strength, corrosion resistance, chemical stability, freeze resistance as well as UV stability.

As an example for this Table 4 shows a comparison between the freeze-thaw cycle stability according to DIN 52104, the chemical stability according to DIN EN ISO 10545, the freeze resistance according to DIN EN ISO 10545, the UV stability and the adhesive strength according to the cross-cut/tape test according to DIN 53151 for the composition of embodiment 2 versus a comparative example without nano particles in which the average particle size of the SiO₂ was 5 μm.

TABLE 4

| | Composition of | |
|---|---|---|
| Test | Embodiment 2 | Comparative Example |
| Freeze thaw cycle (DIN | >350 cycles | About 220 cycles |
| 52104, Part 1A) | | |
| Chemical stability | High (Δm <1%) | Moderate (Δm <15%) |
| (DIN EN ISO 10545, Part | | |
| 13/14) | | |
| freeze resistance | Very good (>250) | Good (<200) |
| (DIN EN ISO 10545, Part | | |
| 12) | | |
| UV stability (Xenon- | Extemely high | Low (max. 15 years) |
| Whom) | (>25 years) | |
| GT/TT* (DIN 53151) | 0/0 | 1/3 |

*cross-cut/tape test

The obtained results clearly prove that by adding the nano-scale particles it is possible to attain an improvement of the freeze-thaw cycle stability, the chemical stability, the freeze resistance and the UV stability.

1-20. (canceled)

21. A coating system comprising a binder further comprising an inorganic phosphatic binder, and a filler, wherein the filler comprises nano-scale particles having an average particle diameter d50 of less than 300 nm.

22. The coating system according to claim 21, wherein the average particle diameter d50 of the nano-scale particles is less than 100 nm.

23. The coating system according to claim 21, wherein the phosphatic binder system comprises at least one phosphate selected from the group consisting of alkali polyphosphates, polymer alkali phosphates, silicophosphates, mono-aluminum phosphate, boron phosphate, magnesium sodium phosphate, alkali silicophasphate, phosphate glass, zinc phosphates, magnesium phosphates, calcium phosphates, titanium phosphates, chromium phosphates, iron phosphates, and manganese phosphates.

24. The coating system according to claim 21, wherein the inorganic phosphatic binder comprises an aluminum phosphate.

25. The coating system according to claim 21, wherein the nano-scale particles comprise at least one oxide or hydroxide selected from the group consisting of aluminum, titanium, zinc, tin, zirconium, silicon, cerium, and magnesium.

26. The coating system according to claim 21, wherein the nano-scale particles comprise at least one compound selected from the group consisting of silicon carbide, titanium carbide, and tungsten carbide.

27. The coating system according to claim 21, wherein the nano-scale particles comprise at least one compound selected from the group consisting of silicon nitride, titanium nitride, and tungsten nitride.

28. The coating system according to claim 23, wherein the inorganic binder system comprises more than 90% mono-aluminum phosphate.

29. The coating system according to claim 23, wherein the mono-aluminum phosphate is a 50-60% aqueous solution.

30. The coating system according claim 21, wherein the coating system comprises an aqueous solution and further comprises at least one sol selected from the group consisting of acid stabilized silica sol, aluminum sol, zirconium sol, titanium dioxide sol, bismuth sol, and tin oxide sol.

31. The coating system according to claim 21, further comprising at least one oxide having a d50 value of 500 nm to 500 μm selected from the group consisting of quartz, cristobalite, aluminum oxide, zirconium oxide, and titanium dioxide.

32. The coating system according to claim 31, wherein the d50 value of the oxide is 500 nm to 10 μm.

33. The coating system according claim 21, further comprising at least one non-oxide with a d50 value in the range of 500 nm to 60 μm selected from the group consisting of silicon carbide, aluminum nitride, boron carbide, boron nitride, titanium nitride, titanium carbide, tungsten carbide, mixed carbides, mixed nitrides, and carbon nitrides.

34. The coating system according to claim 33, wherein the d50 value of the non-oxide is in the range of 500 nm to 12 μm.

35. The coating system according to claim 21, wherein the filler includes at least one silicatic raw material having a d50 value of <70 μm selected from the group consisting of clay, kaolins, and loams.

36. The coating system according to claim 34, wherein the d50 value of the silicatic raw material is in the range of 8 μm-45 μm.

37. The coating system according claim 21, wherein the nano-scale particles are homogeneously distributed in the binder.

38. The coating system according claim 21, wherein the nano-scale particles are inhomogeneously distributed in the binder matrix, a concentration of the nano-scale particles being present in the area of a surface of the other fillers.

39. The coating system according to claim 21, wherein the nano-scale particles are adhered to a surface of the other filler by chemical and/or physical coupling.

40. The coating system according claim 21, wherein the water content of the coating system before the coating is below 45 percent by weight.
